(19) United States
(12) Patent Application Publication
(10) Pub. No.: US 2008/0108250 A1
(43) Pub. Date: May 8, 2008

(54) Connector Equipped With Thermosetting Adhesive Film and Connection Method Using the Same

(76) Inventor: Masashi Shimada, Kanagawa Pref (JP)

Correspondence Address: 3M INNOVATIVE PROPERTIES COMPANY, PO BOX 33427, ST. PAUL, MN, 55133-3427, US

(21) Appl. No.: 11/718,903

(22) PCT Filed: Oct. 19, 2005
(86) PCT No.: PCT/US05/37441

§ 371 Date: May 9, 2007

(30) Foreign Application Priority Data
Nov. 12, 2004 (JP) 2004-329161

(51) Int. Cl. H01R 13/40

(52) U.S. Cl. 439/591

(57) ABSTRACT

A connector equipped with a thermosetting adhesive film for electrically connecting wiring boards with each other, wherein a surface of a terminal portion of a connector to which an electric connection portion of the wiring board is connected has a structured surface and a layer of a thermosetting adhesive applied on the structured surface.

### TECHNICAL FIELD

This invention relates to a connector equipped with a thermosetting adhesive film and a connection method using the connector.

### BACKGROUND

A wiring board such as a flexible circuit (FPC) has generally been connected to another wiring board by using a dedicated connector.

As shown in FIG. 7, the dedicated connector at least includes, as main constituent components, a housing (8) formed of an insulating material as an outer peripheral portion of a connector (10), a plurality of electric contacts (9, 9′) arranged inside the housing and an actuator (6) for facilitating insertion of the FPC wiring board to the connector.

Such a connector is described in Patent Document 1 (Japanese Unexamined Patent Publication (Kokai) No. 2001-357920), for example.

When the dedicated connector for the FPC wiring board is used, a connection portion between two wiring boards swells out due to complicatedness of the structure of the connector, and a problem occurs in the application where reduction of thickness and size is required.

### BRIEF DESCRIPTION OF THE DRAWINGS

FIG. 1 is a perspective view of a connector.

FIG. 2 is a perspective view of a connector of another type.

FIG. 3 is a perspective view of a connector of still another type.

FIG. 4 is a schematic sectional view of the connector shown in FIG. 1.

FIG. 5 is a schematic sectional view of a connector equipped with an adhesive film using a connector according to the invention.

FIG. 6 shows a step of electrically connecting the connector shown in FIG. 5 to a wiring board.

FIG. 7 is a perspective view of an FPC connector according to the prior art.

### DISCLOSURE

It is therefore an object of the present invention to provide a connector capable of reducing the size of a connection portion while securing connection reliability, and a connection method of wiring boards using the connector.

According to one aspect of the invention, there is provided a connector equipped with a thermosetting adhesive film for electrically connecting wiring boards to each other, wherein a surface of a terminal portion of the connector to which an electric connection portion of the wiring board is to be connected has a structured surface, and a layer of a thermosetting adhesive film is deposited to the structured surface.

According to one aspect of the invention, there is provided a connector equipped with a thermosetting adhesive film for electrically connecting wiring boards to each other, wherein the designed terminal portion of said connector has a ratio of terminal width(L) to terminal-to-terminal distance(S) of 0.5 or less, and a layer of a thermosetting adhesive film is present between the designed terminal portion of said connector and the electrical connection portion of said wiring board.

According to one aspect of the invention, there is provided a connector equipped with a thermosetting adhesive film for electrically connecting wiring boards to each other, wherein the designed terminal portion of said connector is non-linear, and a layer of a thermosetting adhesive film is present between the designed terminal portion of said connector and the electrical connection portion of said wiring board.

According to another aspect of the invention, there is provided a connector whose terminal portion is electrically connected to an electric connection portion of a wiring board, wherein the terminal portion of the connector and the electric connection portion of the wiring board are aligned and heat bonded with each other.

According to still another aspect of the invention, there is provided an electric connection method for electrically connecting wiring boards with each other by a connector, including a step of aligning and heat bonding a terminal portion of the connector and an electric connection portion of the wiring board.

The term “structured surface” means a surface having concavo-convexity that provides sufficient contact between the terminal portion of the connector and the electric connection portion of the wiring board when heat bonding is conducted through the thermosetting adhesive film. The “wiring board” includes both a circuit on a rigid substrate and a flexible circuit board such as flexible printed circuit (FPC). The “structured surface” can be formed by emboss processing on a surface having recesses and/or projections.

The term “designed terminal” means a specific design for the terminal portion. There are two types of designed terminals. One is a straight terminal design wherein the ratio of terminal width(L) to terminal-to-terminal distance(S) of the designed terminal portion of said connector is 1 or less, preferably 0.5 or less. The other is a non-linear terminal pattern.

Unlike connection between the wiring boards by using the dedicated connector for the FPC wiring boards according to the prior art, the connector equipped with the adhesive film according to the invention can make the size small.

The surface of the terminal portion of the connector is the structured surface in the connector equipped with the adhesive film according to the invention. Therefore, the projection portions and the electric connection portion of the wiring board can reliably come into mutual contact and eventually, connection can be established reliably. A similar effect from the structured surface is expected by applying a designed terminal. A terminal portion having a smaller L/S ratio or a non-linear terminal can provide a higher concentration of contact pressure at heat bonding and result in mutual contact. When the terminal portion of the connector and the wiring board are heat pressed, an adhesive constituting the thermosetting adhesive film is set, fixes the electric connection portion and can acquire connection stability.

When connection is made through the connector according to the invention, the structured surface or designed terminal need not be formed on the wire itself of the wiring board unlike the case where the wiring boards are directly connected to each other through the thermosetting adhesive film. Therefore, when other electronic components are packaged onto the wiring board, the packaging step is not restricted.

Furthermore, it is difficult to arrange a structured surface on a wiring board having low strength such as a flexible printed circuit (FPC), in particular, but when the connector according to the invention is used, the structured surface need not be formed on the wire itself of the wiring board and connection can be made easily.

Preferred embodiments of the invention will be hereinafter explained but the invention is not limited to the following embodiments.

To begin with, wiring boards to be connected in the invention may be rigid substrates to be connected mutually, flexible substrates to be connected mutually or a combination of the rigid substrate with the flexible substrate, and are not particularly limited. Connectors may have various forms and are not particularly limited.

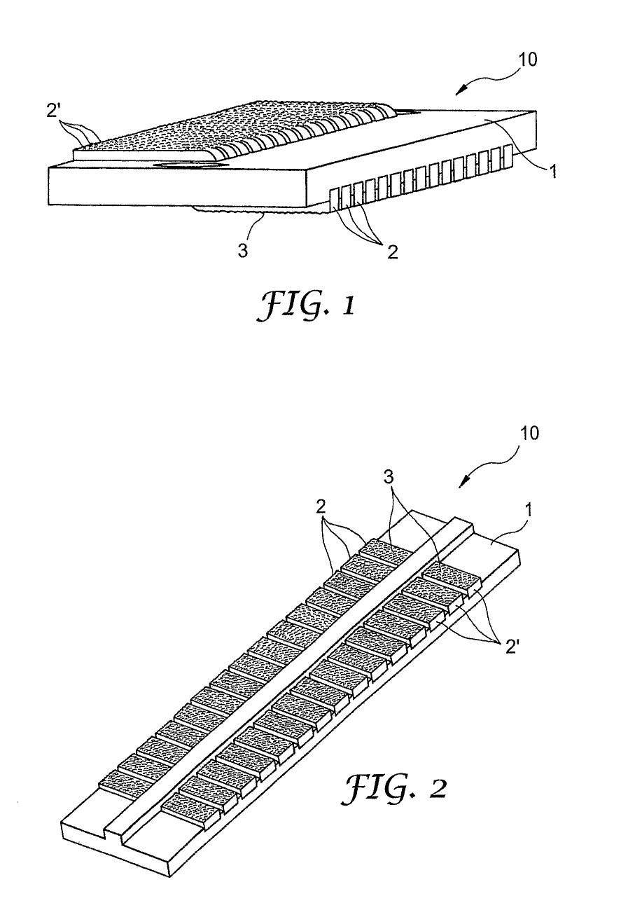

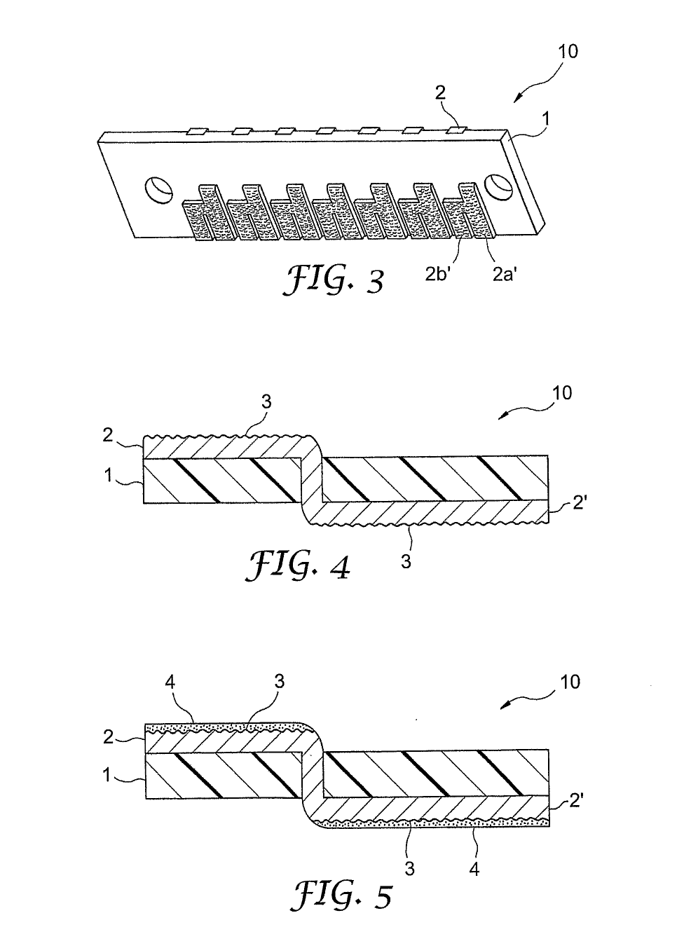

To have the concept of the invention understood, an outline will be explained by using various types of connectors. FIGS. 1 to 3 are perspective views of some types of connectors having structured surface. FIG. 4 is a schematic sectional view of a connector having structured surface. FIG. 1 shows a connector 10 having terminal portion 2 including a plurality of parallel conductors on one of the surfaces of a resin substrate 1 and an another terminal portion 2′ including a plurality of conductors on the opposite surface of a resin substrate 1, with electric conduction of both terminal portions 2. The surfaces of terminal portions 2 and 2′ are structured surfaces 3. FIG. 2 shows another connector 10 having terminal portions 2 and 2′ including a plurality of parallel conductors on the same surface of the resin substrate 1. The surfaces of terminal portions 2 and 2′ are structured surfaces 3. FIG. 3 shows a connector 10 having a terminal portion including a plurality of parallel conductors on one of the surfaces of a resin substrate 1 and an another terminal portion including a plurality of conductors on the opposite surface of a resin substrate 2, with electric conduction of both terminal portions 2, wherein each terminal is branched into a plurality of terminals 2a′ and 2b′. The surfaces of each terminal portion 2 and 2a′ and 2b′ are structured surfaces 3.

FIG. 4 is a schematic sectional view of the connector shown in FIG. 1. The surfaces of the terminal portions 2 and 2′ formed of the conductor have a structured surface 3 as shown in FIG. 4. The conductor of the terminal portions 2 and 2′ is formed of a metal line having high electric conductivity such as copper, though it is not limited to copper. The structured surface 3 can be formed by embossing that presses a surface of an ordinary connector that is to be structured. Since the structured surface has raised portions and recessed portions, at the time of fluidization of an adhesive film, an adhesive is excluded at the raised portions so that the contact of the raised portion of the terminal portion 2 to the connection portion of the wiring board is enhanced. As a result, the structured surface can ensure electric connection between the terminal portion 2 and the connection portion of the wiring board. Therefore, the form of the structured surface is not particularly limited so long as such purpose of the invention can be accomplished. In order to promote the contact between the connection portion of the wiring board and the terminal portion, the structured surface is, for example, formed by embossing with a surface having raised portions and recessed portions. Preferably, height of raised portions and recessed portions formed is uniform.

If the height is uniform, a plurality of contact points are stably formed. In addition, in the case of the structured surface having stripe-like raised and recessed patterns, for example, the structured surface having a height from the recessed portion to the raised portion of 2 to 500 μm, and the pitch between the raised portions of 5 to 1000 μm will cause a preferred result.

In the connector having a linear designed terminal for use in the present invention, the ratio of terminal width(L)/terminal-to-terminal distance(S) is about 1 or less, preferably about 0.5 or less. Because the L/S ratio in general is about 1, the L/S of a linear designed terminal in the present invention is small. With a dimension in such range, when the connector is press-bonded under heat and thereby connected by using a specific thermosetting adhesive film for use in the present invention, good connection can be obtained. This is considered to result because as the ratio of terminal width(L) to terminal-to-terminal(S) is smaller, the pressure imposed on the thermosetting adhesive film becomes higher and it is easier to push away the thermosetting adhesive film and establish contact between the connection part of connector and the connection part of second wiring board. From this standpoint, the ratio of L/S is preferably about 0.3 or less, more preferably about 0.2 or less. A higher pressure can also be achieved with a non-linear designed terminal, which facilitates contact between the connection part of connector and the connection part of second wiring board.

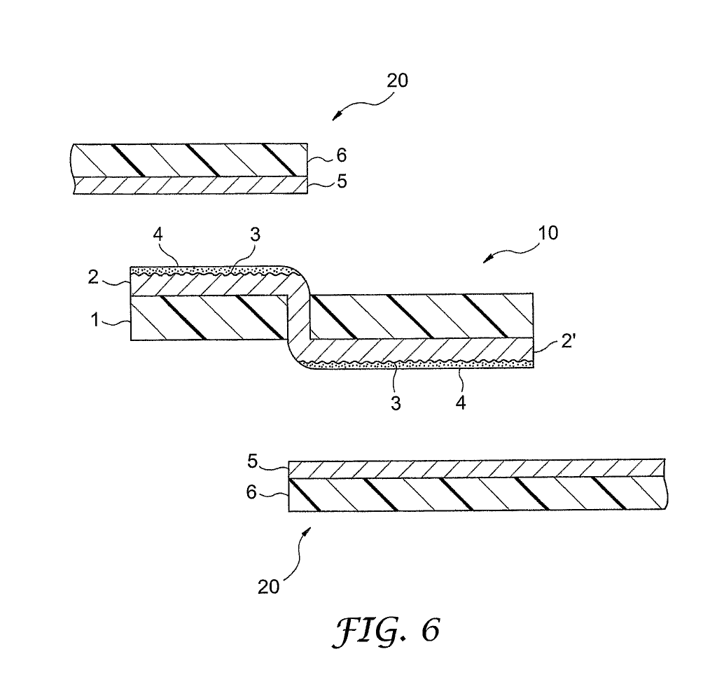

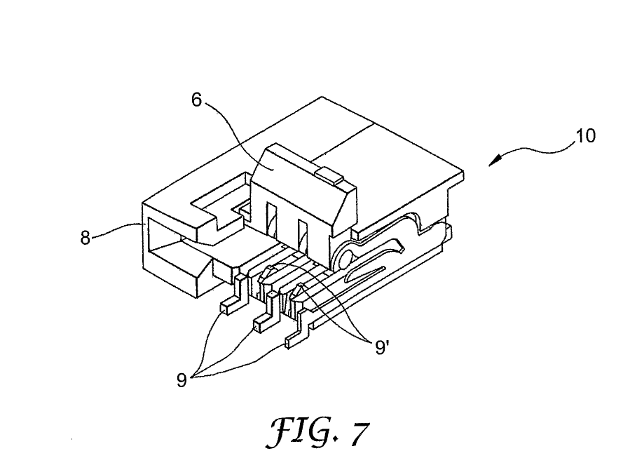

FIG. 5 is a schematic sectional view of a connector equipped with an adhesive film using the connector of the invention shown in FIG. 1. This connector is obtained by arranging an adhesive film 4 formed of a thermosetting adhesive on the terminal portions 2 and 2′ of the connector shown in the drawing and pressing the adhesive film 4 by a heated smooth plate (not shown) to bond the adhesive film 4 to the terminal portions 2 and 2′. Incidentally, the adhesive film formed of the thermosetting adhesive is of such a type that exhibits fluidity and can adhere to the terminal portions 2 and 2′ when heated, undergoes fluidization at the time of connection of the electric connection portion of the wiring board and the terminal portions 2 and 2′ when it is further heated, thereby connecting electrically the electric connection portion and the terminal portions 2 and 2′, and then causes thermosetting. The detail of the thermosetting adhesive used in the invention will be later described. FIG. 6 shows the steps of electrically connecting the connector shown in FIG. 5 to the wiring board. The terminal portions 2 and 2′ on the connector 10 is aligned to the electric connection portion 5 on the wiring board 20 and the adhesive film 4 is arranged on the wiring board 20 and is heat pressed to establish connection. Heat setting is carried out at a temperature and a pressure at which connection between the electric connection portion of the wiring board and the terminal portion of the connector can be sufficiently established and the thermosetting adhesive undergoes sufficient setting. The temperature and the pressure are decided in accordance with a resin composition of an adhesive film selected and are not limited. Generally, it is preferred in the invention to use an adhesive film containing a resin component having a fluidization point of 60 to 170° C. and a setting temperature of 170 to 260° C. In this case, a heating temperature of about 150 to about 230° C., a heating time of 1 to 10 seconds and a pressure of 5 to 200 N/cm² are suitably used for press bonding the connector and the and the adhesive film. To connect the wiring board and the connector, it is preferred to use a heating temperature of 200° C. or above, a heating time of 1 to several minutes and a pressure of 5 to 100 N/cm².

In this connection, the term “fluidization temperature” means a temperature at which the viscosity of a polymer resin is 10,000 Pas or less and can be measured by use of a plastometer or a viscoelastometer. The term “setting temperature” means a temperature at which the setting reaction of the thermosetting polymer proceeds at least 50% in the course of 60 minutes and can be measured by the viscoelastometer or a differential scanning calorimeter (DSC).

The wiring of the invention is not particularly limited and may be of any type. It is possible to use a rigid wiring board having a copper wiring on a rigid substrate such as a glass epoxy substrate, for example. It is also possible to use a flexible wiring board such as a flexible printed circuit (FPC) having a wiring on a thin resin substrate. The connector according to the invention can be used particularly suitably for connecting the flexible wiring boards with each other. In the invention, electric connection is achieved through the adhesive tape as described above. To insure satisfactory connection, a structured surface is formed at the terminal portion of the connector. When the flexible wiring boards are directly connected with each other through the adhesive film, the structured surface must be formed on at least one of the wiring boards. When the structured surface is formed by embossing on the flexible wiring board, the wiring board may accidentally be broken. In the invention, however, connection is made through the connector having the terminal portion having the structured surface. Therefore, the structured surface need not be formed on the flexible wiring board and such a problem can be eliminated.

Next, the adhesive film used in the invention will be described. The invention uses an adhesive film (hereinafter called “thermosetting adhesive film” or “adhesive film”) containing a thermo-fluidizable and thermosetting resin (hereinafter called “thermosetting resin”, too) that exhibits fluidity when heated to a certain temperature and is set when it is further heated. Such a thermosetting resin is the one that contains both of a thermoplastic component and a thermosetting component. The thermo-fluidizable and thermosetting resin can be a mixture of a thermosetting resin such as a phenoxy resin and a thermosetting resin such as an epoxy resin. The thermo-fluidizable and thermosetting resin can be a thermosetting resin that is modified by a thermoplastic component. An example of such a resin is a polycaprolactone-modified epoxy resin. As another example, the thermo-fluidizable and thermosetting resin can be a copolymer resin having a thermosetting group such as an epoxy group in the basic structure of the thermoplastic resin. An example of such a copolymer resin is a copolymer between ethylene and glycidyl.

The adhesive composition that can be used particularly suitably for the adhesive film is a thermosetting adhesive composition including a caprolactone-modified epoxy resin.

Such a thermosetting adhesion composition generally has a crystalline phase. Particularly, the crystalline phase contains the caprolactone-modified epoxy resin (hereinafter called also “modified epoxy resin”) as its main component. The modified epoxy resin applies suitable flexibility to the thermosetting adhesive composition and can improve viscoelastic properties of the thermosetting adhesive. As a result, the thermosetting adhesive has cohesive force before setting and exhibits higher bonding power upon heating. The modified epoxy resin becomes a set product having a three-dimensional network structure by heating in the same way as an ordinary epoxy resin and can apply the cohesive force to the thermosetting adhesive.

From the aspect of the improvement of initial bonding power, the modified epoxy resin generally has an epoxy equivalent of about 100 to about 9,000, suitably about 200 to about 5,000 and more suitably about 500 to about 3,000. A suitable modified epoxy resin having such an epoxy equivalent is commercially available from Dicel Kagaku Kogyo K. K. under the trade designation PLACELL G series.

The thermosetting adhesive composition preferably contains a melamine/isocyanuric acid adduct (hereinafter called “melamine/isocyanuric acid complex”) in combination with the modified epoxy resin described above. A useful melamine/isocyanuric acid complex is commercially available from Nissan Kagaku Kogyo K. K. under the trade designation MC-600, for example, and is effective for increasing toughness of the thermosetting adhesive composition, for reducing tack of the thermosetting adhesive composition before setting by the exhibition of thixotropic property and for suppressing hygroscopicity and fluidity of the thermosetting adhesive composition. To prevent brittleness after setting without spoiling the effect described above, the thermosetting adhesive composition can contain generally 1 to 100 parts by weight, preferably 2 to 100 parts by weight and more preferably 3 to 50 parts by weight, of this melamine/isocyanuric acid complex on the basis of 100 parts by weight of the modified epoxy resin.

If the thermosetting adhesive composition contains a sufficient amount of thermoplastic resin, repairability is imparted to the connector. The term “repairability” means the capacity such that the adhesive film can be peeled by heating after the connection step is carried out and connection can be again made. A phenoxy resin is suitable for the thermoplastic resin. The phenoxy resin is a thermoplastic resin having a chain-like or linear structure and a relatively high molecular weight and consists of epichlorohydrin and bis-phenol A. Such a phenoxy resin has high processability and the thermosetting adhesive composition can be easily processed into the adhesive film. According to the invention, this phenoxy resin is contained in the thermosetting adhesive composition generally in an amount of 10 to 300 parts by weight and preferably 20 to 200 parts by weight on the basis of 100 parts by weight of the modified epoxy resin. Because the phenoxy resin is effectively compatible with the modified epoxy resin. In this way, bleed of the modified epoxy resin from the thermosetting adhesive composition can be effectively prevented. The phenoxy resin entangles with the set product of the modified epoxy resin and further improves final aggregation force and heat resistance of the thermosetting adhesive layer. Furthermore, the repairability after connection can be secured.

The thermosetting adhesive composition may optionally further contain a second epoxy resin (hereinafter merely called “epoxy resin”) in combination with, or independently of, the phenoxy resin described above. This epoxy resin is not particularly limited so long as it is not out of the scope of the invention. It is possible to use, for example, a bis-phenol A type epoxy resin, a bis-phenol F type epoxy resin, a bis-phenol A glycidyl ether type epoxy resin, a phenol novolak type epoxy resin, a cresol novolak type epoxy resin, a fluorene epoxy resin, a glycidylamine resin, an aliphatic epoxy resin, a brominated epoxy resin, a fluorinated epoxy resin, and so forth. Such epoxy resins are compatible with the phenoxy resin in the same way as the modified epoxy resin and their bleed from the thermosetting adhesive composition hardly occurs. The heat resistance can be improved advantageously particularly when the thermosetting adhesive composition contains suitably 50 to 200 parts by weight and more suitably 60 to 140 parts by weight of the second epoxy resin on the basis of 100 parts by weight of the modified epoxy resin.

In the embodiment of the invention, a bis-phenol A glycidyl ether type epoxy resin (hereinafter called “diglycidyl ether type epoxy resin”) can be used as the preferred epoxy resin. This diglycidyl ether type epoxy resin is liquid and, for example can improve high temperature characteristics of the thermosetting adhesive composition. When this diglycidyl ether type epoxy resin is used, chemical resistance due to setting at a high temperature and a glass transition temperature, for example, can be improved. An application range of the curing agent can be enlarged and the setting condition is relatively mild. Such a diglycidyl ether type epoxy resin is commercially available from Dow Chemical (Japan) Co. under the trade designation D.E.R. 332.

A curing agent can be optionally added to the thermosetting adhesive composition and can be used for the setting reaction of the modified epoxy resin and the second epoxy resin. The amount of use of this curing agent and its kind are not particularly limited so long as the curing agent provides the desired effect. From the aspect of the improvement of the heat resistance, however, the thermosetting adhesive composition contains generally 1 to 50 parts by weight, preferably 2 to 40 parts by weight and more preferably 5 to 30 parts by weight of the curing agent on the basis of 100 parts by weight of the modified epoxy resin and the optional second epoxy resin. Examples of the curing agent, though not restrictive, include an amine curing agent, an acid anhydride, dicyandiamide, a cationic polymerization catalyst, an imidazole compound, a hydrazine compound, and so forth. Dicyandiamide, in particular, can be cited as a promising curing agent because it has thermal stability at room temperature. In connection with the diglycidyl ether type epoxy resin, alicyclic polyamine, polyamide, amide amine and their modified products are preferably used.

In the thermosetting adhesive composition, 35 to 100 parts by weight of organic particles can be added based on 100 parts by weight of the adhesive composition described above. When the organic particles are added, the resin comes to show plastic fluidity while restricts excessive fluidity of the thermosetting adhesive composition and prevents the adhesive from flowing out during heat pressing in the bonding step of the adhesive film to the connector and in the connection step with the wiring board. Although moisture adhering to the wiring board is likely to evaporate to generate a vapor pressure during heat in the connection step with the wiring board, in such a condition, the resin fluidizes and does not entrap bubbles therein.

The organic particles added are those of an acrylic resin, a styrene-butadine resin, a styrene-butadiene-acryl resin, a melamine resin, a melamine-isocyanaturate adduct, polyimide, a silicone resin, polyether imide, polyether sulfone, polyester, polycarbonate, polyether ether ketone, polybenzoimidazole, polyallylate, liquid crystal polymer, an olefin resin and an ethylene-acryl copolymer. The particle size is 10 μm or below and preferably 5 μm or below.

Unlike connection using a dedicated connector for an FPC wiring board, the connector equipped with the adhesive film according to the invention can reduce the thickness and size of the connection portion.

Because the connector equipped with the adhesive film according to the invention can secure sufficient bonding strength, mechanical connection strength can be acquired.

When connection is made through the connector of the invention, the structured surface need not be disposed on the wire itself on the wiring board and the packaging step is not limited when other electronic components are packaged. Furthermore, connection between the flexible printed circuits (FPC) is easy.

1. A connector equipped with a thermosetting adhesive film for electrically connecting wiring boards to each other, wherein a surface of a terminal portion of said connector to which an electric connection portion of said wiring board is to be connected has a structured surface, and a layer of a thermosetting adhesive film is deposited on the structured surface.

2. A connector equipped with a thermosetting adhesive film according to claim 1, wherein said thermosetting adhesive film contains both of a thermoplastic component and a thermosetting component.

3. A connector equipped with a thermosetting adhesive film according to claim 2, wherein said thermosetting adhesive film consists of a thermosetting adhesive composition containing a caprolactone-modified epoxy resin.

4. A connector equipped with a thermosetting adhesive film according to claim 1, wherein the connector has repairability.

5. A connector whose terminal portion is electrically connected to an electric connection portion of a wiring board, wherein the terminal portion of said connector equipped with a thermosetting adhesive film according to claim 1 and the electric connection portion of said wiring board are aligned and heat bonded with each other.

6. An electric connection method for electrically connecting wiring boards with each other by a connector, including a step of aligning and heat bonding a terminal portion of the connector equipped with a thermosetting adhesive film according to claim 1 and an electric connection portion of the wiring board.

7. A connector equipped with a thermosetting adhesive film for electrically connecting wiring boards to each other, wherein the designed terminal portion of said connector has a ratio of terminal width(L) to terminal-to-terminal distance(S) of 0.5 or less, and a layer of a thermosetting adhesive film is present between the designed terminal portion of said connector and the electrical connection portion of said wiring board.

8. A connector equipped with a thermosetting adhesive film according to claim 7, wherein said thermosetting adhesive film contains both of a thermoplastic component and a thermosetting component.

9. A connector equipped with a thermosetting adhesive film according to claim 8, wherein said thermosetting adhesive film consists of a thermosetting adhesive composition containing a caprolactone-modified epoxy resin.

10. A connector equipped with a thermosetting adhesive film according to claim 7, wherein the connector has repairability.

11. A connector whose terminal portion is electrically connected to an electric connection portion of a wiring board, wherein the terminal portion of said connector equipped with a thermosetting adhesive film according to claim 7 and the electric connection portion of said wiring board are aligned and heat bonded with each other.

12. An electric connection method for electrically connecting wiring boards with each other by a connector, including a step of aligning and heat bonding a terminal portion of the connector equipped with a thermosetting adhesive film according to claim 7 and an electric connection portion of the wiring board.

13. A connector equipped with a thermosetting adhesive film for electrically connecting wiring boards to each other, wherein the designed terminal portion of said connector is non-linear, and a layer of a thermosetting adhesive film is present between the designed terminal portion of said connector and the electrical connection portion of said wiring board.

14. A connector equipped with a thermosetting adhesive film according to claim 13, wherein said thermosetting adhesive film contains both of a thermoplastic component and a thermosetting component.

15. A connector equipped with a thermosetting adhesive film according to claim 14, wherein said thermosetting adhesive film consists of a thermosetting adhesive composition containing a caprolactone-modified epoxy resin.

16. A connector equipped with a thermosetting adhesive film according to claim 13, wherein the connector has repairability.

17. A connector whose terminal portion is electrically connected to an electric connection portion of a wiring board, wherein the terminal portion of said connector equipped with a thermosetting adhesive film according to claim 13 and the electric connection portion of said wiring board are aligned and heat bonded with each other.

18. An electric connection method for electrically connecting wiring boards with each other by a connector, including a step of aligning and heat bonding a terminal portion of the connector equipped with a thermosetting adhesive film according to claim 13 and an electric connection portion of the wiring board.
